(19) United States
(12) Patent Application Publication
(10) Pub. No.: US 2015/0339751 A1
(43) Pub. Date: Nov. 26, 2015

(54) DYNAMIC PRICING MODEL

(71) Applicant: Lakshmanan Velusamy, Bellevue, WA (US)

(72) Inventor: Lakshmanan Velusamy, Bellevue, WA (US)

(21) Appl. No.: 14/286,742

(22) Filed: May 23, 2014

(51) Int. Cl. G06Q 30/06; G06F 17/30

(52) U.S. Cl. CPC G06Q 30/0625; G06F 17/30867

(57) ABSTRACT

A system to provide a dynamic pricing model is described. An item listing in an on-line trading platform may be designated as being a subject to dynamic pricing functionality. When an item listing, that has a dynamic pricing option enabled, is selected for inclusion into the search results, a dynamic pricing system determines whether the search results are to be ordered according to respective prices associated with the listings and whether the listing is at the top of the list of the search results. If the original price associated with the listing is such that the listing would not be placed at the top of the list of the search results, the dynamic pricing system may reduce the price associated with the listing such that, based on the reduced price value, the listing can be positioned at the top of the search results list.

### TECHNICAL FIELD

This application relates to the technical fields of software and/or hardware technology and, in one example embodiment, to system and method to provide a dynamic pricing model.

### BACKGROUND

An on-line trading platform allows users to shop for almost anything using, e.g., a web browser application or an application native to a mobile device. A user may find an item listed by an on-line trading application by entering keywords into the search box provided on an associated web page or by browsing through the list of categories on the home page. After reading the item description and viewing the seller's reputation, the user may be able to either place a bid on the item or purchase it instantly. There are many features provided by an on-line trading application that may be utilized by users in unique ways that may result in a successful shopping experience. A user may encounter an item of interest on a web site other than a web site associated with the on-line trading platform. The user may be able to determine keywords that describe that item of interest, access the web site associated with the on-line trading platform and attempt to locate that item in the on-line trading platform.

### BRIEF DESCRIPTION OF DRAWINGS

Embodiments of the present invention are illustrated by way of example and not limitation in the figures of the accompanying drawings, in which like reference numbers indicate similar elements and in which:

FIG. 1 is a diagrammatic representation of a network environment within which an example method and system to provide a dynamic pricing model may be implemented;

FIG. 2 is block diagram of a system to provide a dynamic pricing model, in accordance with one example embodiment;

FIG. 3 is a flow chart of a method to provide a dynamic pricing model, in accordance with an example embodiment;

FIG. 4 is an example user interface (UI) screen illustrating an item listing with a dynamic pricing option; and

FIG. 5 is a diagrammatic representation of an example machine in the form of a computer system, within which a set of instructions, for causing the machine to perform any one or more of the methodologies discussed herein, may be executed.

### DETAILED DESCRIPTION

Method and system are described for utilizing a dynamic pricing model. In the following description, for purposes of explanation, numerous specific details are set forth in order to provide a thorough understanding of example embodiments. It will be evident, however, to one skilled in the art that the present invention may be practiced without these specific details.

As used herein, the term “or” may be construed in either an inclusive or exclusive sense. Similarly, the term. “exemplary” is merely to mean an example of something or an exemplar and not necessarily a preferred or ideal means of accomplishing a goat. Additionally, although various exemplary embodiments discussed below may utilize Java-based servers and related environments, the embodiments are given merely for clarity in disclosure. Thus, any type of server environment, including various system architectures, may employ various embodiments of the application-centric resources system and method described herein and is considered as being within a scope of the present invention.

In the context of an on-line trading platform, when a potential buyer enters search terms in a search box provided by an on-line trading platform, the associated search system returns search results, which may be arranged in a certain order. For example, the items in the search results may be listed based on respective prices, where the less expensive items are listed at the top of the list and the more expensive items are listed towards the bottom of the list. The items listed at the top of search results may attract more attention from potential buyers than listings that appear in further down in the search results. A system to provide a dynamic pricing model, also termed a dynamic pricing system, permits users of an on-line trading platform to list their items with a price that can be changed automatically, based on the placement of the item listing in the search results.

According to one example embodiment, an item listing in an on-line trading platform may be designated as being a subject to dynamic pricing functionality. At the time an item listing is being created or edited, a user may be permitted to select a dynamic pricing option and designate one or more parameters associated with the dynamic pricing option, such as, e.g., the amount or percentage, by which the price can be reduced in order to move the listing further towards the top of the list of search results. In operation, when an item listing, that has a dynamic pricing option enabled, is selected for inclusion into the search results, a dynamic pricing system determines whether the search results are to be ordered according to respective prices associated with the listings and whether the listing is at the top of the list of the search results. If the original price associated with the listing is such that the listing would not be placed at the top of the list of the search results, the dynamic pricing system may reduce the price associated with the listing such that, based on the reduced price value, the listing can be positioned at the top of the search results list.

For example, an item listing for a mobile phone (termed a target listing for the purposes of this example) may list the price of $100 and may also have a dynamic pricing option enabled, indicating that the price of $100 may be reduced, if needed, down to $90 or by 10%. When a user of the on-line trading platform enters the words “mobile” and “phone” into a search box provided by an associated search system, the search system retrieves search results and may, based on the user's settings or request, organize the search results according to respective prices, with the least expensive items shown towards the top of the list. The dynamic pricing system may determine the difference between the price associated with the item listing that was placed at the top of the search results (the lowest price in the search results) and the original price associated with the target listing and determines the amount, by which the price associated with the target listing can be reduced in order to move the target listing to the top or towards the top of the list of the search results. The price associated with the target listing may be reduced in this manner temporarily, only for the purposes of presentation of the target listing in that particular list of search results. If, for example, another search is conducted and the target listing appears at the top of the list, or if the search results are not listed in an order based on respective prices associated with the listings, the target listing appears in that list of search results with its original price.

The dynamic pricing system selects a value that may be slightly greater than the lowest price in the search results (e.g., less than the lowest price in the search results by a predetermined amount, such as $1) and determines whether the parameter associated with the dynamic pricing option set for the target listing permits the reduction of the price associated with the target listing to that value. For example, if the lowest price in the list of search results is $85, the dynamic pricing system reduces the price associated with the target listing to $90 (in other words, by 10% permitted according to the parameter associated with the dynamic pricing option enabled for the target listing). The target listing will not appear at the top of the list of search results, but may still appear further towards the top of the list. In some embodiments, if the dynamic pricing system determines that the reduction of the price associated with the target listing does not result in a change of the position of the target listing in the list of search results, the dynamic pricing system does not reduce the price associated with the target listing.

In another scenario, if the lowest price in the list of search results is $97, the dynamic pricing system reduces the price associated with the target listing to $96 (in other words, down to the amount that is less than the lowest price in the search results by $1). The target listing would then appear at the top of the list of search results. It will be noted, that, in some embodiments, the dynamic pricing system may be configured to inspect the listings in the search results with respect to a dynamic pricing option indicator (a dynamic pricing option indicator indicating whether the dynamic pricing option is enabled for an item listing) only if the search results are to be ordered based on respective prices associated with the listings, in a descending order.

In a still further scenario, the list of search results may include item listings of different categories. For example, the search results may include listings of mobile phones, as well as listings of mobile phone accessories. The dynamic pricing system may be configured to detect the item listing with the lowest price from the listings in the search results that are associated with the same category as the target listing and ignore the listings from other categories. In the example where the search results include listings of mobile phones and also listings of mobile phone accessories, the dynamic pricing system would not take into account the item listings from the mobile phone accessories category.

In yet another scenario, the dynamic pricing system may detect more than one item listings with the positive dynamic pricing option indicators. If, for example, two item listings in the list of search results have the dynamic pricing option enabled, and respective parameters of the dynamic pricing option for both item listings permit the reduction of respective associated prices to the value that is less than the lowest price in the search results, the dynamic pricing system determines which item listing is to be placed at the top of the search results based on various additional factors, such as, e.g., the feedback scores of the respective sellers, the age of the listing, etc.

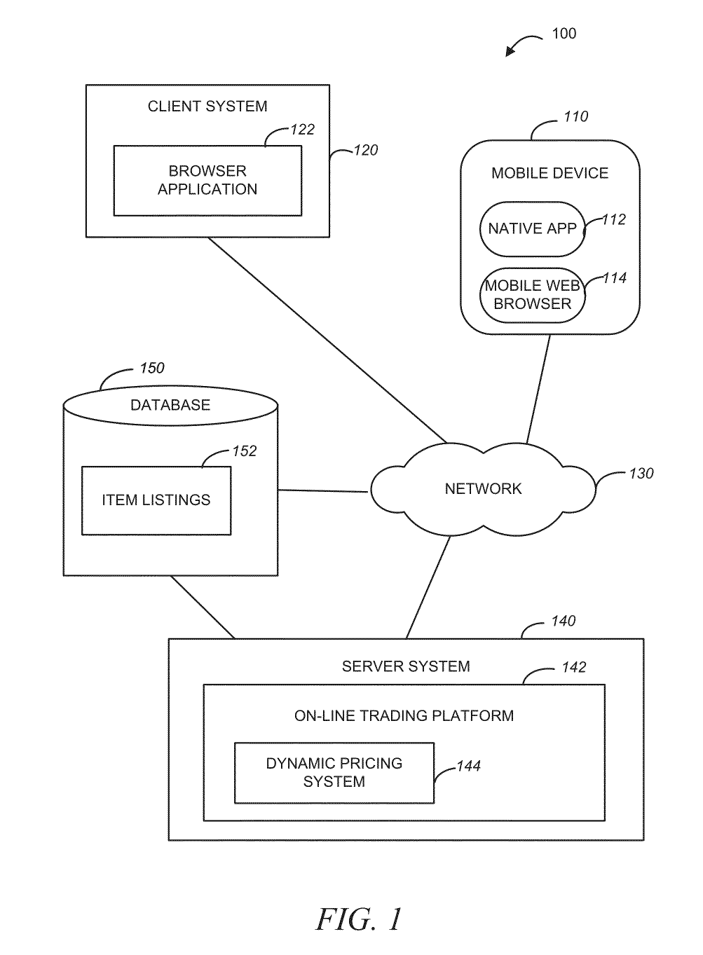

An example method and system to provide a dynamic pricing model may be implemented in the context of a network environment 100 illustrated in FIG. 1. As shown in FIG. 1, the network environment 100 may include a client devices 110 and 120, and a server system 140. The client device 110 may be executing a native app 112 and/or a mobile web browser 114. The native app 112 may be providing access to services executing on the server system 140, such as, e.g., to services provided by the on-line trading platform 142. The client devices 110 and 120 may have access to the server system 140 hosting the on-line trading platform 142 via a communications network 130. The communications network 130 may be a public network (e.g., the Internet, a mobile communication network, or any other network capable of communicating digital data).

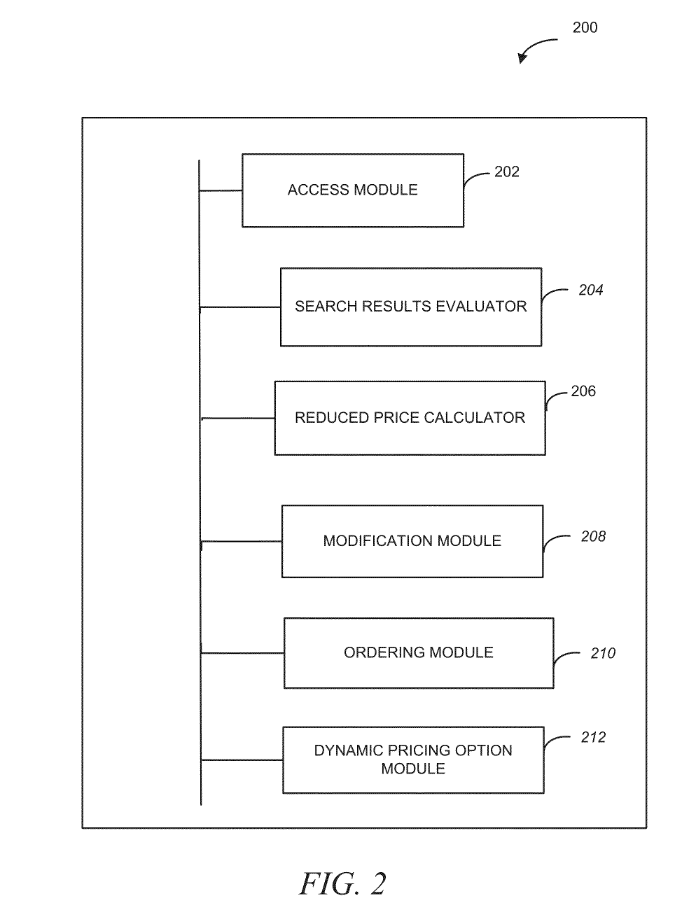

As shown in FIG. 1, the server system 140 is in communication with a database 150 that stores item listings 152. The server system 140 also hosts a dynamic pricing system 144. In one example embodiment, the dynamic pricing system 144 is configured to permit users of the on-line trading platform 142 to list their items with a price that can be changed automatically, based on the placement of the item listing in the search results. As explained above, the dynamic pricing system 144 may detect that the search results produced in response to a search request directed at the on-line trading platform 142 are to be ordered based on respective prices associated with the listings in the search results, in a descending order. If a listing in the search results has the dynamic pricing option enabled, the dynamic pricing system 144 examines the reduction limit parameter provided in the listing that has the dynamic pricing option enabled (termed a target listing), examines the price a listing in the search results that has the lowest price, and, based on the reduction limit parameter and the price associated with the listing in the search results that has the lowest price, determines an amount, by which the original price associated with the target listing is to be reduced in order to place the target listing at the top or close to the top of the search results, when the search results are displayed to a user. An example system that includes functionality to provide a dynamic pricing model is illustrated in FIG. 2.

FIG. 2 is a block diagram of a system 200 to provide a dynamic pricing model, in accordance with one example embodiment. As shown in 2, the system 200 includes an access module 202, a search results evaluator 204, a reduced price calculator 206, and a modification module 208. The access module 202 may be configured to access search results generated in the on-line trading platform 142 of FIG. 1, where the search results comprise a plurality of item listings. The search results evaluator 204 may be configured to determine that the search results are to be ordered based on respective prices associated with listings in the plurality of item listings. The search results evaluator 204 may also be configured to detect a target listing in the search results that has a dynamic pricing option enabled, where the dynamic pricing option is associated with a reduction limit parameter. As explained above, a reduction limit parameter may be expressed as an amount, by which it is permissible to automatically reduce the original price associated with the target listing, or a percent value indicating the percent by which it is permissible to automatically reduce the original price associated with the target listing. The search results evaluator 204 may also be configured to determine that the search results include listings associated with a first category and listings associated with a second category (e.g., in the search results related to mobile phones, some of the results may be from a “phone” category and other results from “phone accessories” category), and that the target listing associated with the first category. The search results evaluator 204 may then select the lowest price listing from listings in the search results that are associated with the first category.

The reduced price calculator 206 may be configured to determine a reduced price value for the target listing, based on the reduction limit parameter and a price associated with a lowest price listing from the plurality of listings, where the lowest price listing having the lowest price as compared to respective prices associated with other listing from the plurality of listings. The reduced price value may be utilized by the modification module 208 configured to modify, in the search results, a price of the target listing to the reduced price value. The modification module 208 may also be configured to modify, in the search results, a price of another listing from the plurality of listings to the same reduced price value as the reduced price value for the target listing. The modification module 208 may then designate the target listing for placement in the search results closer to the top of a list of the search results than the further listing, based respective feedback ranks in a seller profile associated with the target listing and a seller profile associated with the further listing.

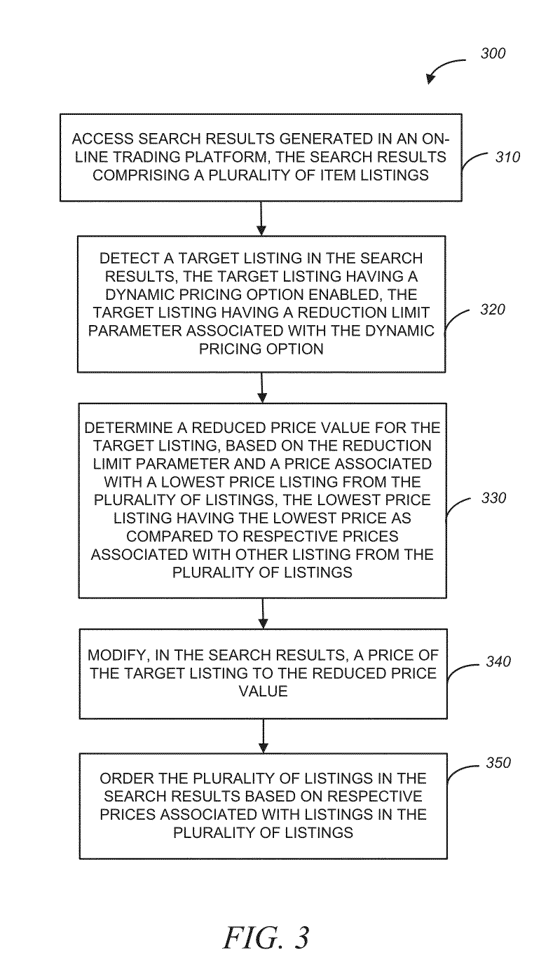

Also shown in FIG. 2 are an ordering module 210 and a dynamic pricing option module 212. The ordering module 210 may be configured to order the plurality of listings in the search results based on respective prices associated with listings in the plurality of listings. The dynamic pricing option module 212 may be configured to receive a request to create a new listing in the on-line trading platform 1424, and, in response to the request, present to a user a user interface that includes an option to activate dynamic pricing functionality for the new listing. The dynamic pricing option module 212 may also be configured to detect a selection of the option to activate dynamic pricing functionality for the new listing and obtain a reduced price parameter via a user interface, the reduced price parameter indicating a price reduction measure (also termed a reduction limit parameter) for the new listing. Example operations performed by the system 200 are described with reference to FIG. 3.

FIG. 3 is a flow chart of a method 300 to provide a dynamic pricing model, according to one example embodiment. The method 300 may be performed by processing logic that may comprise hardware (e.g., dedicated logic, programmable logic, microcode, etc.), software (such as run on a general purpose computer system or a dedicated machine), or a combination of both. In one example embodiment, the processing logic resides at the server system 140 of Fig 1.

As shown in FIG. 3, the method 300 commences at operation 310, when the access module 202 of FIG. 2 accesses search results generated in the on-line trading platform 142 of FIG. 1, where the search results comprise a plurality of item listings. The search results evaluator 204 of FIG. 2 determines that the search results are to be ordered based on respective prices associated with listings in the plurality of item listings and, at operation 320, detects a target listing in the search results that has a dynamic pricing option enabled. As explained above, the dynamic pricing option may be associated with a reduction limit parameter that may be expressed as an amount, by which it is permissible to automatically reduce the original price associated with the target listing, or a percent value indicating the percent by which it is permissible to automatically reduce the original price associated with the target listing. At operation 330, the reduced price calculator 206 of FIG. 2 determines a reduced price value for the target listing, based on the reduction limit parameter and a price associated with a lowest price listing from the plurality of listings, where the lowest price listing has the lowest price as compared to respective prices associated with other listing from the plurality of listings.

At operation 340, the modification module 208 of FIG. 2 modifies, in the search results, the original price of the target listing to the reduced price value. In a scenario where the modification module 208 modifies respective prices of two listings that have a dynamic pricing option enabled, the modification module 208 may designates one of those listings for placement in the search results closer to the top of a list of the search results, based respective feedback ranks in a seller profile associated with the target listing and a seller profile associated with the further listing. At operation 350, the ordering module 210 of FIG. 2 orders the plurality of listings in the search results based on respective prices associated with listings in the plurality of listings.

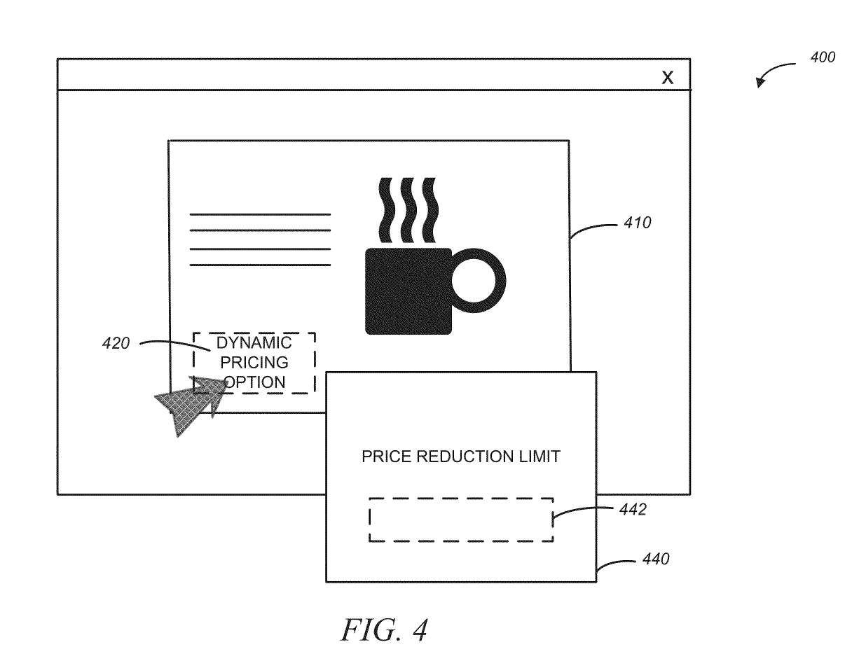

FIG. 4 is an example user interface (UI) screen 400 illustrating an item listing with a dynamic pricing option. As shown in FIG. 4, the screen 400 includes a picture and a description of the item in area 410, and a dynamic prizing option control 420 that may be utilized to activate the dynamic pricing option functionality. When a user activates the dynamic prizing option control 420, the dynamic pricing system presents the user with a window 440 that maybe used to populate a field 442 with a reduction limit parameter.

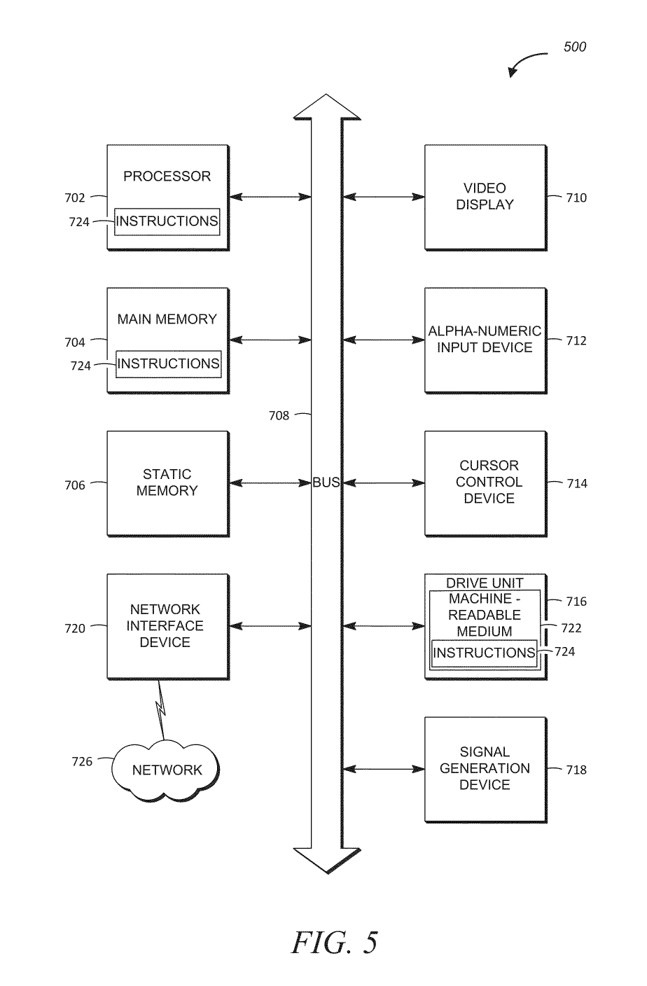

FIG. 5 is a diagrammatic representation of a machine in the example form of a computer system 700 within which a set of instructions, for causing the machine to perform any one or more of the methodologies discussed herein, may be executed. In alternative embodiments, the machine operates as a stand-alone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 700 includes a processor 702 (e.g., a central processing unit (CPU), a graphics processing unit (GPU) or both), a main memory 704 and a static memory 706, which communicate with each other via a bus 707, The computer system 700 may further include a video display unit 710 (e.g., a liquid crystal display (LCD) or a cathode ray tube (CRT)). The computer system 700 also includes an alpha-numeric input device 712 (e.g., a keyboard), a user interface (UI) navigation device 714 (e.g., a cursor control device), a drive unit 716, a signal generation device 718 (e.g., a speaker) and a network interface device 720.

The drive unit 716 includes a machine-readable medium 722 on which is stored one or more sets of instructions and data structures (e.g., software 724) embodying or utilized by any one or more of the methodologies or functions described herein, The software 724 may also reside, completely or at least partially, within the main memory 704 and/or within the processor 702 during execution thereof by the computer system 700, with the main memory 704 and the processor 702 also constituting machine-readable media.

The software 724 may further be transmitted or received over a network 726 via the network interface device 720 utilizing any one of a number of well-known transfer protocols (e.g., Hyper Text Transfer Protocol (HTTP)).

While the machine-readable medium 722 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing and encoding a set of instructions for execution by the machine and that cause the machine to perform any one or more of the methodologies of embodiments of the present invention, or that is capable of storing and encoding data structures utilized by or associated with such a set of instructions. The term “machine-readable medium” shall accordingly be taken to include, but not be limited to, solid-state memories, optical and magnetic media. Such media may also include, without limitation, hard disks, floppy disks, flash memory cards, digital video disks, random access memory (RAMs), read only memory (ROMs), and the like. Furthermore, the tangible machine-readable medium is non-transitory in that it does not embody a propagating signal. However, labeling the tangible machine-readable medium as “non-transitory” should not be construed to mean that the medium is incapable of movement—the medium should be considered as being transportable from one physical location to another, Additionally, since the machine-readable medium is tangible, the medium may be considered to be a machine-readable device.

The embodiments described herein may be implemented in an operating environment comprising software installed on a computer, in hardware, or in a combination of software and hardware. Such embodiments of the inventive subject matter may be referred to herein, individually or collectively, by t le term “invention” merely for convenience and without intending to voluntarily limit the scope of this application to any single invention or inventive concept if more than one is, in fact, disclosed.

### MODULES, COMPONENTS AND LOGIC

Certain embodiments are described herein as including logic or a number of components, modules, or mechanisms. Modules may constitute either software modules (e.g., code embodied (1) on a non-transitory machine-readable medium or (2) in a transmission signal) or hardware-implemented modules. A hardware-implemented module is tangible unit capable of performing certain operations and may be configured or arranged in a certain manner. In example embodiments, one or more computer systems (e.g., a standalone, client or server computer system) or one or more processors may be configured by software (e.g., an application or application portion as a hardware-implemented module that operates to perform certain operations as described herein.

In various embodiments, a hardware-implemented module may be implemented mechanically or electronically. For example, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a general-purpose processor or other programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired) or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time, For example, where the hardware-implemented modules comprise a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules can provide information to, and receive information from, other hardware-implemented modules, Accordingly, the described hardware-implemented modules may be regarded as being communicatively coupled. Where multiple of such hardware-implemented modules exist contemporaneously, communications may be achieved through signal transmission (e.g., over appropriate circuits and buses) that connect the hardware-implemented modules. In embodiments in which multiple hardware-implemented. modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., Application Program Interfaces (APIs).)

Thus, method and system to provide a dynamic pricing model has been described. Although embodiments have been described with reference to specific example embodiments, it will be evident that various modifications and changes may be made to these embodiments without departing from the broader scope of the inventive subject matter. Accordingly, the specification and drawings are to be regarded in an illustrative rather than a restrictive sense.

1. A method comprising:
access search results generated an on-line trading platform, the search results comprising a plurality of item listings;
detect a target listing in he search results, the target listing having a dynamic pricing option enabled, the target listing having a reduction limit parameter associated with the dynamic pricing option;
determine a reduced price value for the target listing, based on the reduction limit parameter and a price associated with a lowest price listing from the plurality of listings, the lowest price listing having the lowest price as compared to respective prices associated with other listing from the plurality of listings; and
modify, in the search results, a price of the target listing to the reduced price value, utilizing at least one processor.

2. The method of claim 1, ordering the plurality of listings in the search results based on respective prices associated with listings in the plurality of listings.

3. The method of claim 1, comprising determining that the search results are to be ordered based on respective prices associated with listings in the plurality of item listings, in a descending order.

4. The method of claim 1, comprising determining that the search results include listings associated with a first category and listings associated with a second category, the target listing associated with the first category.

5. The method of claim 4, comprising selecting the lowest price listing from listings in the search results that are associated with the first category.

6. The method of claim 1, comprising modifying in the search results, a price of a further listing from the plurality of listings to the reduced price value, the further listing having the dynamic pricing option enabled.

7. The method of claim 6, designating the target listing for placement in the search results closer to the top of a list of the search results than the further listing, based respective feedback ranks in a seller profile associated with the target listing and a seller profile associated with the further listing.

8. The method of claim 1, comprising:
receiving a request to create a new listing in the on-line trading platform; and
presenting a user interface including an option to activate dynamic pricing functionality for the new listing.

9. The method of claim 8, comprising:
detecting, via a user interface, a selection of the option to activate dynamic pricing functionality for the new listing; and
obtaining a reduced price parameter, the reduced price parameter indicating a price reduction measure for the new listing.

10. The method of claim 9, comprising storing the new listing in a database associated with the on-line trading platform.

11. A computer-implemented system comprising:
at least one processor coupled to a memory;
an access module to access search results generated in an on-line trading platform, the search results comprising a plurality of item listings, utilizing at least one processor;
a search results evaluator to detect a target listing in the search results, the target listing having a dynamic pricing option enabled, the target listing having a reduction limit parameter associated with the dynamic pricing option, utilizing at least one processor;
a reduced price calculator determine a reduced price value for the target listing, based on the reduction limit parameter and a price associated with a lowest price listing from the plurality of listings, the lowest price listing having the lowest price as compared to respective prices associated with other listing from the plurality of listings, utilizing at least one processor; and
a modification module to modify, in the search results, a price of the target listing to the reduced price value, utilizing at least one processor.

12. The system of claim 11, comprising an ordering module to order the plurality of listings in the search results based on respective prices associated with listings in the plurality of listings.

13. The system of claim 11, wherein the search results evaluator is to determine that the search results are to be ordered based on respective prices associated with listings in the plurality of item listings.

14. The system of claim 11, wherein the search results evaluator is to determine that the search results include listings associated with a first category and listings associated with a second category, the target listing associated with the first category.

15. The system of claim 14, wherein the search results evaluator is to select the lowest price listing from listings in the search results that are associated with the first category.

16. The system of claim 11, wherein the modification module is to modify, in the search results, a price of a further listing from the plurality of listings to the reduced price value, the further listing having the dynamic pricing option enabled.

17. The system of claim 16, wherein the modification module is to designate the target listing for placement in the search results closer to the top of a list of the search results than the further listing, based respective feedback ranks in a seller profile associated with the target listing and a seller profile associated with the further listing.

18. The system of claim 11, comprising a dynamic pricing option module to:
receive a request to create a new listing in the on-line trading platform; and
present a user interface including an option to activate dynamic p cine functionality for the new listing.

19. The system of claim 8, wherein the dynamic pricing option module is to:
detect a selection of the option to activate dynamic pricing functionality for the new listing; and
obtain a reduced price parameter via a user interface, the reduced price parameter indicating a price reduction measure for the new listing.

20. A machine-readable non-transitory storage medium having instruction data to cause a machine to:
access search results generated in an on-line trading platform, the search results comprising a plurality of item listings;
detect a target listing in the search results, the target listing having a dynamic pricing option enabled, the target listing having a reduction limit parameter associated with the dynamic pricing option;
determine a reduced price value for the target listing, based on the reduction limit parameter and a price associated with a lowest price listing from the plurality of listings, the lowest price listing having the lowest price as compared to respective prices associated with other listing from the plurality of listings; and
modify, in the search results, a price of the target listing to the reduced price value.
